(19) United States
(12) Patent Application Publication
(10) Pub. No.: US 2026/0204506 A1
(43) Pub. Date: Jul. 16, 2026

(54) FUSE UNIT

(71) Applicant: Yazaki Corporation, Tokyo (JP)

(72) Inventors: Norio Matsumura, Shizuoka (JP); Masayoshi Ozawa, Shizuoka (JP)

(21) Appl. No.: 19/426,676

(22) Filed: Dec. 19, 2025

(30) Foreign Application Priority Data
Jan. 14, 2025 (JP) 2025-004550

(51) Int. Cl. H01H 85/20; H01H 85/045

(52) U.S. Cl. CPC H01H 85/2045; H01H 85/045

(57) ABSTRACT

A use unit includes: a fusible link; and a cover configured to be mounted on the fusible link from one side in a first direction. The cover is integrated by coupling two cover surfaces with a coupling portion at the one side in the first direction, the two cover surfaces being parallel to each other along the first direction and spaced apart in a second direction perpendicular to the first direction. The cover is formed with a cutout portion by locally removing the coupling portion and the two cover surfaces from the one side in the first direction. The fusible link is formed with a cover locking portion that locks an end portion of the cutout portion on the other side in the first direction at the time of mounting the cover so as to limit movement of the cover toward the one side in the first direction.

### CROSS-REFERENCE TO RELATED APPLICATION(S)

This application is based upon and claims the benefit of priority from prior Japanese patent application No. 2025-004550 filed on January 14, 2025, the entire contents of which are incorporated herein by reference.

### BACKGROUND

### 1. Field of the Invention

The present disclosure relates to a structure for a fuse unit provided with a fuse that fuses due to an overcurrent.

### 2. Description of the Related Art

In an automobile or the like, a fuse unit is used in which a plurality of fuses (fuse portions) that fuse due to an overcurrent are provided in parallel. In such a fuse unit, it is required that the state of the fuse portion can be easily visually checked, and therefore the fuse unit is mounted in a box provided on a substrate or the like when used. This allows an operator to remove the fuse unit from the box and visually check the state of the fuse portion (whether fused or not) if an abnormality occurs. The structure for such a fuse unit is described in, for example, JP2021-166160.

In the fuse unit, a plurality of fuse portions are arranged and provided. As described above, it is required that the operator be able to visually check the state of these fuse portions, while it is also necessary to mechanically protect the fuse portions. For this reason, this fuse unit is formed by attaching a transparent resin cover to a housing provided with the plurality of fuse portions. The fuse unit is mounted in the box by fitting a bus bar (pin) that protrudes downward from a lower side of the housing and serve as a terminal into a terminal on a bottom surface inside the box. Therefore, the fuse unit can be easily attached to and detached from the box.

In the housing of the fuse unit, the plurality of fuse portions are arranged in a horizontal direction, and the bus bars are also arranged in the horizontal direction on the lower side correspondingly. The cover has a generally U-shaped cross section that sandwiches the housing, and is mounted to the housing from a lateral direction, thereby covering the arrangement of the fuse portions. In this case, the cover can be easily attached to and detached from the housing. Meanwhile, the fuse unit can be attached to and detached from the box in an upper-lower direction perpendicular to the horizontal direction, which is a direction in which the cover is attached and detached.

As described above, the fuse unit in the form in which the easily detachable cover is mounted on the housing is further accommodated and fixed in the box. Accordingly, there are various structural limitations on the fuse unit.

For example, it is necessary to provide a locking mechanism on the housing to lock the cover (to prevent it from falling off) after mounting, but in cases where the cover is mounted by sliding along the horizontal direction (direction in which the fuse portions are arranged), the location where the locking mechanism can be provided is limited, especially when there are a large number of fuse portions. Furthermore, since the housing has a complicated structure as described above, the cover that covers the housing needs to have a cross-sectional shape that corresponds to this structure, and a long distance is required for the cover to move at the time of mounting. Therefore, the mounting is not always easy.

Further, when the fuse unit is mounted in the box in the upper-lower direction as described above, the fuse unit is fixed to the box by engaging the plurality of bus bars (pins) provided on the lower side of the fuse unit with the terminals on the box side. However, if a single fuse unit is provided with many fuse portions (wirings), it becomes necessary to provide a corresponding number of bus bars, and in some cases, it may be necessary to provide some bus bars not only on the lower side of the fuse unit but also on a side surface side. In this case, in order to prevent the cover from interfering with the bus bar, the layout is restricted or a cover with a more complicated structure is required.

For this purpose, for example, a configuration in which the cover is mounted to the housing along the upper-lower direction is possible. However, in this case, there is a problem in that the cover falls off when the fuse unit to which the cover is mounted is detached from the box, or the fuse unit is not easily detached from the box. For this reason, there has been a demand for a fuse unit that allows the cover to be easily attached and detached, and that can be easily attached to and detached from the box when the cover is being mounted.

### SUMMARY

The present disclosure is made in view of the above circumstances and an object thereof is to solve the above problems.

According to an aspect of the present disclosure, there is provided a fuse unit including: a fusible link that has a structure in which a fuse portion functioning as a fuse is provided in a wiring; and a cover that is transparent and detachably mounted on the fusible link so as to cover the fuse portion, in which the cover is configured to be mounted on the fusible link from one side in a first direction along the first direction, in which the cover is integrated by coupling two cover surfaces with a coupling portion at the one side in the first direction, and is configured to sandwich the fusible link between the two cover surfaces at a time of mounting, the two cover surfaces being parallel to each other along the first direction and spaced apart in a second direction perpendicular to the first direction, in which the cover is formed with a cutout portion by locally removing the coupling portion and the two cover surfaces from the one side in the first direction, and in which the fusible link is formed with a cover locking portion that protrudes locally and locks an end portion of the cutout portion on the other side in the first direction at the time of mounting the cover so as to limit movement of the cover toward the one side in the first direction.

Since the present disclosure is configured as described above, it is possible to obtain a fuse unit that allows the cover to be easily attached and detached, and that can be easily attached to and detached from the box when the cover is being mounted.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view of a fuse unit according to an embodiment;

FIG. 2 is an exploded perspective view of the fuse unit according to the embodiment;

FIG. 3A is a front view of a fusible link in the fuse unit according to the embodiment, and FIG. 3B is a front view of a wiring pattern therein;

FIGS. 4A and 4B are perspective views of a fusible link housing portion of the fusible link as viewed from two different directions;

FIGS. 5A and 5B are a front view and a side view of a cover of the fuse unit according to the embodiment;

FIGS. 6A and 6B are cross-sectional views showing states in which the cover is mounted on the fusible link in the fuse unit according to the embodiment;

FIG. 7 is an assembly perspective view showing a state when mounting the fuse unit according to the embodiment in a box;

FIGS. 8A and 8B are a perspective view and a top view, respectively, of a state in which the fuse unit according to the embodiment is mounted in the box; and

FIGS. 9A and 9B are cross-sectional views of a portion without a cutout portion and a portion with the cutout portion, respectively, in a state where the fuse unit according to the embodiment is mounted in a box.

### DETAILED DESCRIPTION OF THE INVENTION

A fuse unit according to an embodiment of the present disclosure will be described. The fuse unit is used by being mounted in a box provided on a substrate or the like, similar to the technique described in JP2021-166160. Hereinafter, structures of a fusible link (corresponding to the housing in JP2021-166160) and a cover in the fuse unit will be mainly described.

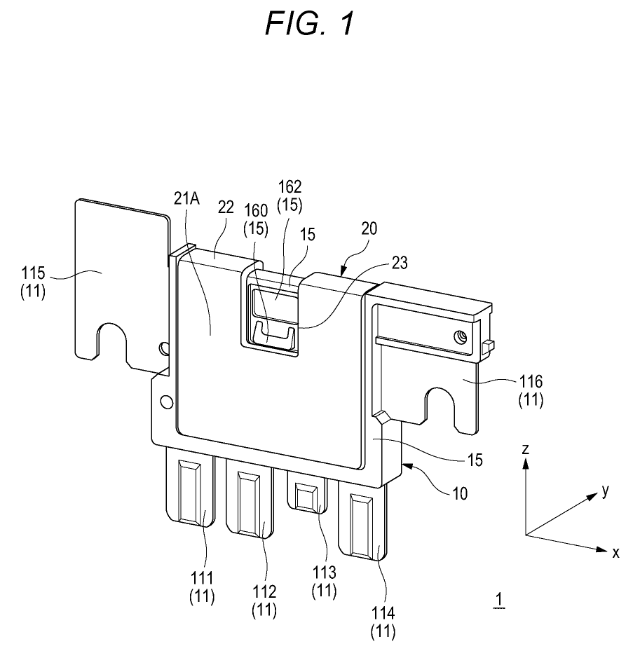

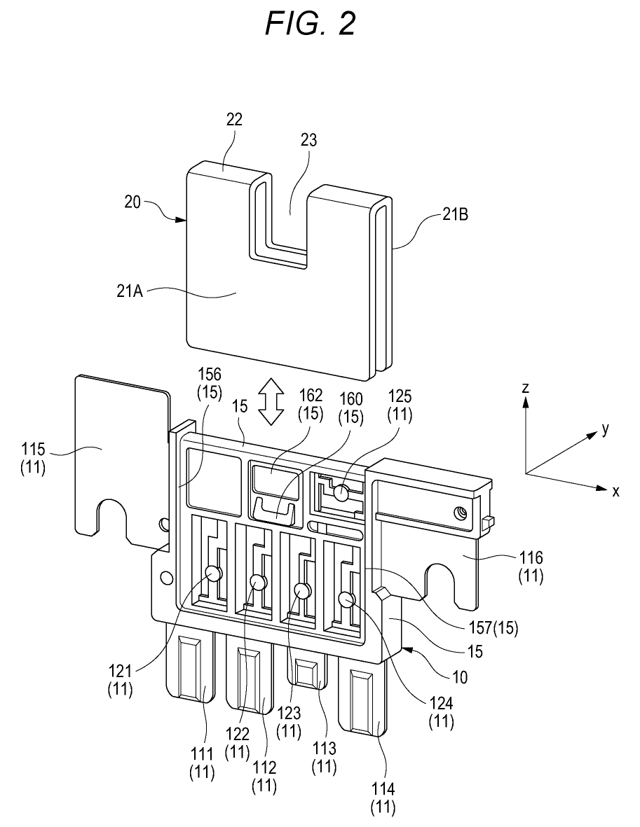

FIG. 1 is a perspective view of a fuse unit 1 according to the embodiment with a cover 20 attached. The fuse unit 1 is formed by detachably attaching the cover 20 to a fusible link 10 provided with five fuses (fuse portions). FIG. 2 is an exploded perspective view illustrating a state where the fusible link 10 and the cover 20 are separated from each other when viewed from the same direction as in FIG. 1. In reality, the cover 20 is made of a transparent resin material, but for convenience, the cover 20 is described here as being opaque. In FIGS. 1 and 2, an x direction (third direction), a y direction (second direction), and a z direction (first direction) are defined as illustrated.

As illustrated in FIG. 2, the cover 20 is mounted on the fusible link 10 from a positive side (upper side: one side) in the z direction. As will be described later, the fuse unit 1 to which the cover 20 is attached is also attached by fitting four bus bars 111 to 114 protruding from a lower side (negative side in the z direction) into a box (not shown) from the positive side in the z direction. A direction in which the bus bars 111 to 114 are arranged is the x direction, and the fuse unit 1 (fusible link 10) is formed thin in the y direction perpendicular to the x direction and the z direction so that it can be easily accommodated in a box, which will be described later.

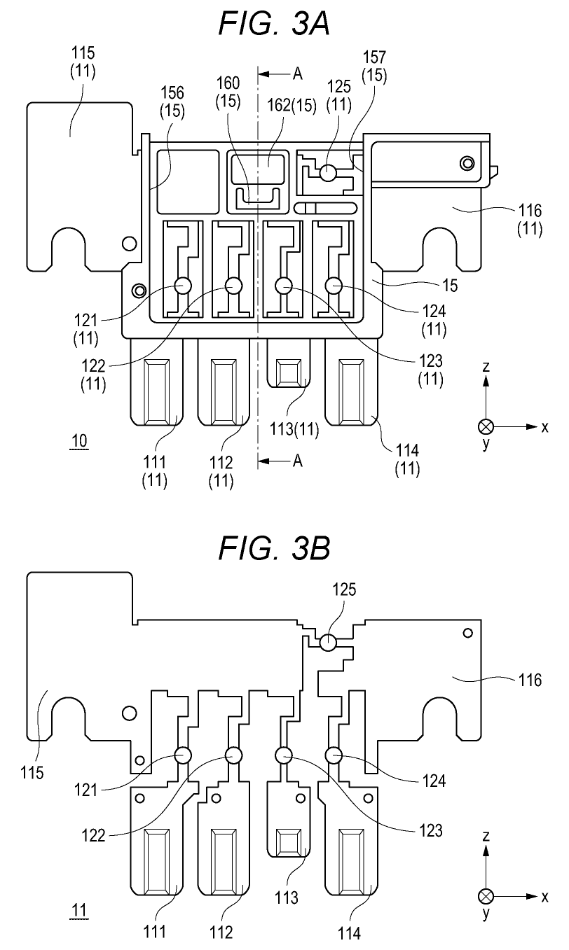

FIG. 3A is a front view of a lower part of the fusible link 10 in FIG. 2 as viewed from a negative side in the y direction. As illustrated here, the fusible link 10 includes a wiring pattern 11 made of a metal plate and a fusible link housing portion 15 made of a resin material molded and fixed to the wiring pattern 11. FIG. 3B shows a front view, similar to FIG. 3A, of the wiring pattern 11 before the fusible link housing portion 15 is molded.

In the wiring pattern 11 shown in FIG. 3B, the bus bars 111 to 114 are formed side by side along the x direction in parallel on the lower side (negative side in the z direction), and above them, bus bars 115 and 116 larger than the bus bar 111 and the like are provided on the left side (negative side in the x direction) and the right side (positive side in the x direction) on an upper side. The bus bars are connected to each other by wiring of a metal plate as shown in the drawing, a region where a wiring width is locally narrowed is provided in the wiring, and a small circular fuse portion made of a low-melting-point metal that fuses when an overcurrent flows is provided in the region. Specifically, a fuse portion 121 is provided between the bus bar 115 and the bus bar 111, a fuse portion 122 is provided between the bus bar 115 and the bus bar 112, a fuse portion 123 is provided between the bus bar 115 and the bus bar 113, a fuse portion 124 is provided between the bus bar 116 and the bus bar 114, and a fuse portion 125 is provided between the bus bar 115 and the bus bar 116. Of these, the fuse portions 121 to 124 are arranged in the x direction in correspondence with the bus bars 111 to 114.

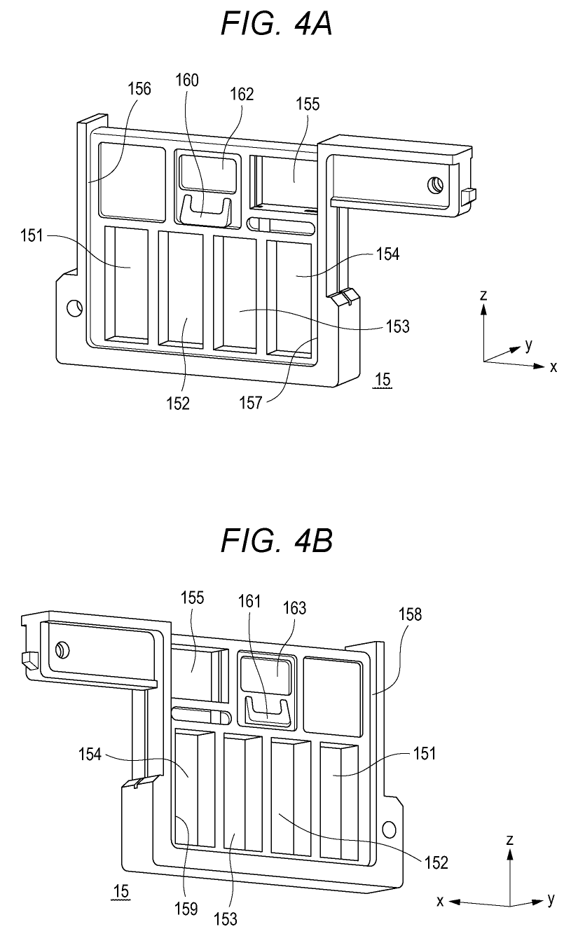

In the fusible link 10 illustrated in FIG. 3A, the fusible link housing portion 15 is formed of a resin material with the above-mentioned bus bars and fuse portions exposed. FIGS. 4A and 4B are perspective views illustrating the structure of the fusible link housing portion 15 as viewed from the negative side and the positive side in the y direction. The fusible link housing portion 15 is formed with window portions 151 to 155 through which the fuse portions 121 to 125 are exposed, respectively. In addition, on an outer side in the x direction of the region in which the window portions 151 to 155 are formed, cover guide portions 156 (on the negative side in the x direction) and 157 (on the positive side in the x direction), which are steps that make the fusible link housing portion 15 thicker on the outer side in the x direction in order to guide the cover 20 from the positive side in the z direction, are formed on the negative side in the y direction (FIG. 4A), and similarly cover guide portions 158 (on the negative side in the x direction) and 159 (on the positive side in the x direction) are formed on the positive side in the y direction (FIG. 4B).

Further, on the negative side in the y direction (FIG. 4A) and the positive side in the y direction (in FIG. 4B), a cover locking portion 160 (161) which is a locally protruding convex portion is formed near the middle between the cover guide portion 156 (158) and the cover guide portion 157 (159) and on the positive side of the z direction. The cover locking portions 160 and 161 are positioned at the same position in the z direction. When viewed from the negative side and the positive side in the y direction, the cover locking portions 160 and 161 both have a U shape with an open upper side (positive side in the z direction). On the upper side (the positive side in the z direction) of the cover locking portions 160 and 161, surfaces of the fusible link housing portion 15 are locally dug down to form recessed portions 162 and 163, each of which has an approximately rectangular shape with each side aligned along the x direction and z direction.

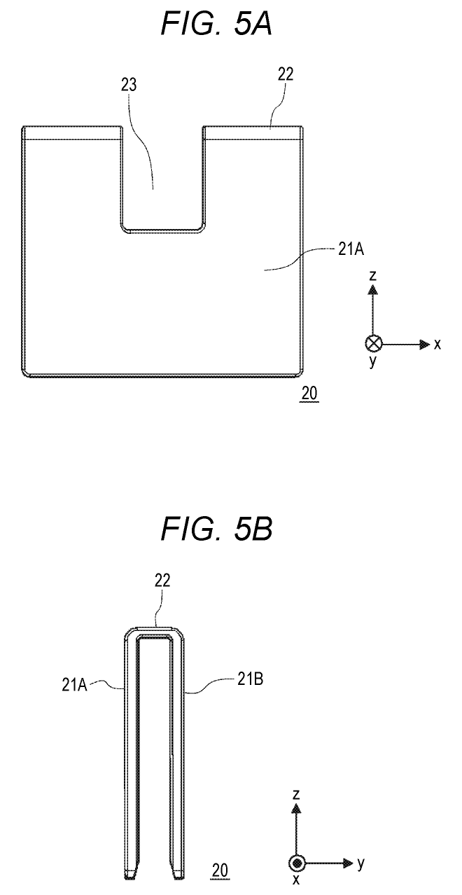

FIG. 5A is a front view of the cover 20 as seen from the negative side in the y direction, and FIG. 5B is a side view of the cover 20 as seen from the positive side in the x direction. As described above, the cover 20 is formed of a transparent resin material and is elastically deformable, but here it is shown in a state where no external force is applied to it. As illustrated in FIG. 5B, the cover 20 has a U shape closed on the positive side in the z direction, and cover surfaces 21A and 21B, which are plate-shaped portions on the negative side and the positive side in the y direction, are coupled by a coupling portion 22 on the positive side in the z direction. The cover 20 is made of an elastic resin material, but when no external force is applied to the cover 20, a distance between the cover surface 21A and the cover surface 21B is equal to the thickness of the fusible link housing portion 15 except for the location where the cover locking portion 160 (161) that protrudes locally between the cover guide portion 156 (158) and the cover guide portion 157 (159) is located.

Therefore, as illustrated in FIGS. 1 and 2, the cover 20 can be mounted on the fusible link 10 (fusible link housing portion 15) from the positive side in the z direction. At this time, the mounting can be easily performed by locking end sides on the negative side and the positive side in the x direction of the cover 20 in FIG. 5A to the cover guide portions 156 to 159.

Further, as illustrated in FIG. 5A, on the positive side of the cover 20 in the z direction (the side on which the coupling portion 22 is located), a cutout portion 23 is provided from the cover surface 21A to the cover surface 21B by cutting the cover 20 (the coupling portion 22 and the cover surfaces 21A and 21B) from the positive side in the z direction. The cutout portion 23 has a rectangular shape in a front view (FIG. 5A) with the lower side aligned in the x direction and both sides in the x direction aligned in the z direction.

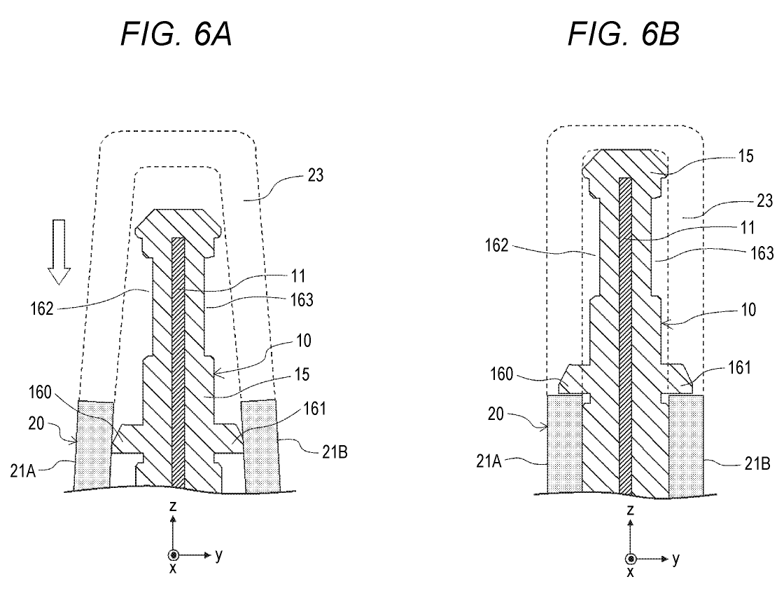

FIGS. 6A and 6B are cross-sectional views perpendicular to the x direction (direction AA in FIG. 3A) at a position where the cover locking portions 160 and 161 are provided, illustrating a state when the cover 20 is mounted on the fusible link 10. As described above, the cover 20 is mounted on the fusible link 10 from the upper side in the z direction. At this time, as illustrated in FIG. 6A, the cover surfaces 21A and 21B come into contact with the cover locking portions 160 and 161, respectively, and accordingly, the cover 20 is elastically deformed so as to be widened on the lower side (an interval between the cover surfaces 21A and 21B is widened).

Thereafter, as illustrated in FIG. 6B, in a state where the lower side of the cutout portion 23 in the cover 20 reaches the lower side of the cover locking portions 160 and 161, the shape of the cover 20 becomes the initial state shown in FIG. 5B. In order to move the cover 20 upward (the positive side in the z direction) from this state to the state shown in FIG. 6A, the lower side of the cutout portion 23 is locked by the cover locking portions 160 and 161, which requires a large force or requires the cover 20 to be deformed so that it opens from the lower side. Therefore, in practice, the cover 20 is stably mounted on the fusible link 10.

In addition, since the cover 20 is formed of a transparent resin material, in the state of FIG. 1 in which the cover 20 is mounted, the state of the fuse portions 121 to 125 (whether they are fused or not) can be visually checked through the cover 20.

When many fuse portions are provided in the fusible link, as shown in FIGS. 3A and 3B, each fuse portion is often provided corresponding to each bus bar, so that the fuse portions are generally arranged in the lateral direction (x direction). In this case, in the technique described in JP2021-166160, since the cover is mounted from the lateral direction (x direction), the cover needs to cross the arrangement of the fuse portions at the time of mounting, which requires a longer moving distance and makes the cover larger. Accordingly, the cover locking portion that locks the cover at the time of mounting also needs to be provided outside the arrangement of the fuse portions. Therefore, there are many restrictions on the position and shape of the cover locking portion, or on the corresponding locking structure on the cover side. Alternatively, the cover locking portion and the locking structure cannot be formed in a sufficiently large size, resulting in insufficient fixation of the cover. Further, when the bus bars are also provided on the outer side in the lateral direction as the bus bars 115 and 116 in FIG. 3, the structure of the cover needs to be made more complex so that the bus bars and the cover do not interfere with each other.

On the other hand, in the above structure, the cover 20 can be mounted with a short moving distance, the cover 20 can be made small, the amount of the resin material forming the cover 20 can be reduced, and the cost can be reduced. According to such a structure of the cover 20, in the above structure, the cover locking portions 160 and 161 for locking the cutout portion 23 can be provided on the upper side of the arrangement of the fuse portions, and the cover locking portions 160 and 161 can be formed sufficiently large as illustrated. Further, the cover 20 does not interfere with the bus bars 115 and 116 provided in the lateral direction at the time of mounting. In addition, in order to protect the fuse portions, it is necessary to provide the cutout portion outside of the region where the fuse portion is located. However, in the above configuration, the cutout portion 23 is provided on the upper side of the arrangement of the fuse portions 121 to 124 and on the left side of the fuse portion 25, so that each fuse portion is reliably protected by the cover 20.

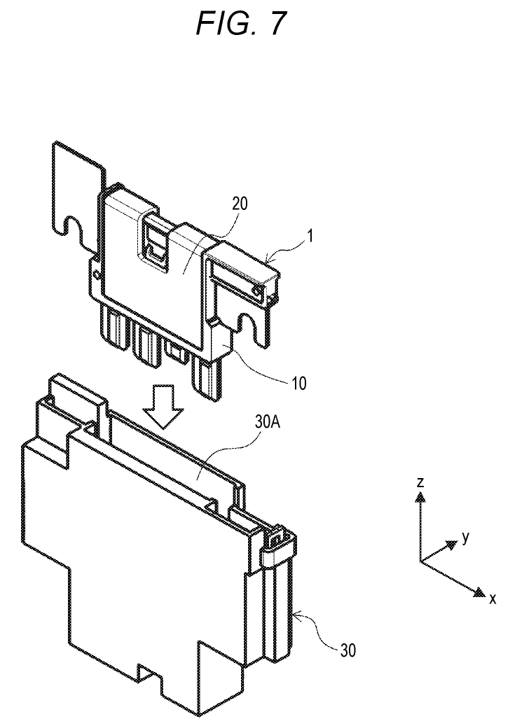

As described above, the fuse unit 1 is actually used by being mounted in a box fixed to a substrate or the like. FIG. 7 is a perspective view showing a state of assembly at this time. The box 30 includes a box internal space 30A in which the fuse unit 1 can be accommodated from the positive side in the z direction. In the box internal space 30A, there is a terminal structure on a bottom surface side (negative side in the z direction) that engages with the bus bars 111 to 114, fixing them and making electrical contact with each of them, a terminal structure on a side surface side (negative side in the x direction) that engages with the bus bar 115, fixing it and making electrical contact with it, and a terminal structure on a side surface side (positive side in the x direction) that engages with the bus bar 116, fixing it and making electrical contact with it, but since these structures are unrelated to the present disclosure and are general, the description thereof will be omitted.

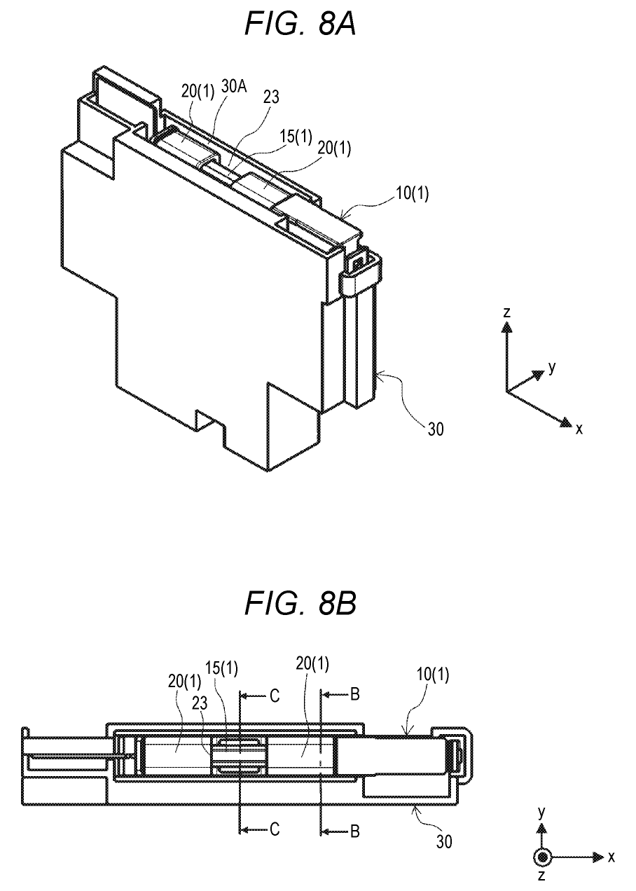

FIG. 8A is a perspective view showing a state in which the fuse unit 1 is mounted in the box 30, and FIG. 8B is a top view thereof as viewed from the positive side in the z direction. Here, the z direction and the like are the same as those shown in FIG. 1. In order to prevent the fuse unit 1 from vibrating in the box internal space 30A in this state, the width of the box internal space 30A in the y direction is substantially equal to the maximum width of the fuse unit 1 in the y direction.

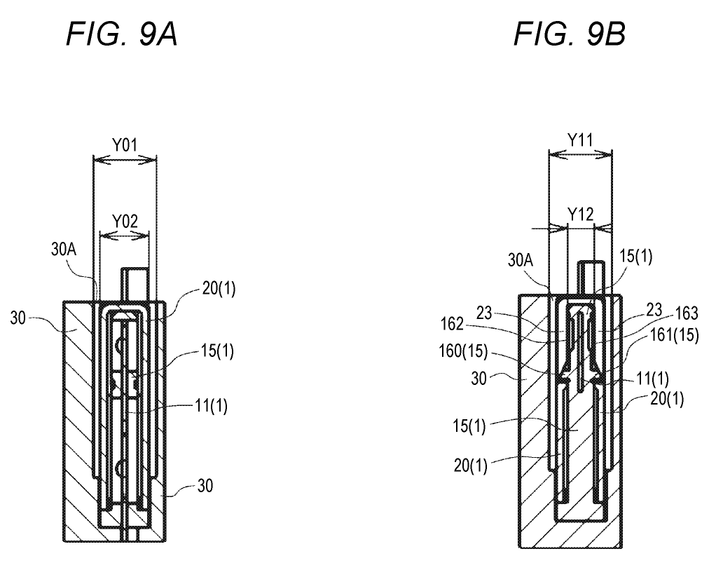

FIG. 9A is a cross-sectional view taken along a line B-B in FIG. 8B (a portion without the cutout portion 23), and FIG. 9B is a cross-sectional view taken along a line C-C in FIG. 8B (a portion with the cutout portion 23 (cover locking portions 160 and 161)). In FIG. 9A, Y01 is the width of the box internal space 30A on the upper side along the y direction, and Y02 is the width of the fuse unit 1 at this position along the y direction, which is equal to the width of the cover 20 along the y direction. In this case, Y02 < Y01 to enable accommodation, but Y02 is set close to Y01 to restrain vibrations and the like as described above.

When the fuse unit 1 is detached from the box 30, it is necessary to grip the upper part of the fuse unit 1 and pull it out upward (in the z direction), in the opposite way to that shown in FIG. 7. In this regard, in the structure of FIG. 9A, Y02 ≈ Y01, so there is no space for gripping the fuse unit 1 on the upper side. In a structure in which the cover is attached from the side, such as the fuse unit described in JP2021-166160, it is possible to ensure that the cover is not present above the fuse unit, so this problem does not occur, but in a structure in which the cover 20 is attached from above, such as the present disclosure, this problem does occur.

In this regard, at the location where the cutout portion 23 is provided, as shown in FIG. 9B, the width Y11 along the y direction of the box internal space 30A is equal to Y01, but the width Y12 along the y direction of the fuse unit 1 at this location is the width of the fusible link housing portion 12, and Y12 < Y02. As a result, in the region shown in FIG. 9B, the space for gripping the fuse unit 1 on the upper side is larger than that in the case of FIG. 9A, and the fuse unit 1 (fusible link housing portion 15) can be easily gripped in this portion and the fuse unit 1 can be pulled out upward.

Further, in this case, as illustrated in FIGS. 1 and 6B, the recessed portions 162 and 163 formed on the upper side of the cover locking portions 160 and 161 are exposed in the cutout portion 23. In this case, the operation of pulling out the fuse unit 1 can be particularly easily performed by engaging a tool for gripping the fuse unit 1 with the recessed portions 162 and 163.

That is, by providing the cutout portion 23 in the cover 20, even in the case of the fuse unit 1 in which the cover 20 is mounted from the upper side, it can be particularly easily removed from the box 30. Therefore, for example, it is possible to easily perform the operation of pulling out the fuse unit 1 (portions where the recessed portions 162 and 163 are located) using a tool at the cutout portion 23 in FIG. 8A.

That is, in the fuse unit 1, the cover 20 can be easily attached and detached, and the fuse unit 1 to which the cover 20 is mounted can be easily attached and detached to and from the box 30.

In the above example, the fusible link 10 and the cover 20 have the shapes illustrated in FIGS. 1, 2 and the like, but these shapes can be set appropriately depending on the wiring pattern within the fusible link and the shape of the box in which the wiring pattern is mounted. The shape of the cutout portion in the cover and the arrangement and shape of the cover locking portion on the fusible link side can also be appropriately set accordingly.

The present disclosure has been described above based on the embodiment. The embodiment is merely an example, and it will be understood by those skilled in the art that various modifications are possible in combinations of components in the embodiment, and that the modifications are also within the scope of the present disclosure.

1. A fuse unit comprising:
a fusible link that has a structure in which fuse portions functioning as a fuse is provided in a wiring; and
a cover that is transparent and detachably mounted on the fusible link so as to cover the fuse portions,
wherein the cover is configured to be mounted on the fusible link from one side in a first direction along the first direction,
wherein the cover is integrated by coupling two cover surfaces with a coupling portion at the one side in the first direction, and is configured to sandwich the fusible link between the two cover surfaces at a time of mounting, the two cover surfaces being parallel to each other along the first direction and spaced apart in a second direction perpendicular to the first direction,
wherein the cover is formed with a cutout portion by locally removing the coupling portion and the two cover surfaces from the one side in the first direction, and
wherein the fusible link is formed with a cover locking portion that protrudes locally and locks an end portion of the cutout portion on the other side in the first direction at the time of mounting the cover so as to limit movement of the cover toward the one side in the first direction.

2. The fuse unit according to claim 1,
wherein the cover locking portion is provided on each side of the fusible link that comes into contact with each of the two cover surfaces.

3. The fuse unit according to claim 1,
wherein in the fusible link, the fuse portions are arranged along a third direction that is perpendicular to the first direction and the second direction, and
wherein the cover locking portion is formed on the one side in the first direction relative to arrangement of the fuse portions.

4. The fuse unit according to claim 3,
wherein a recessed portion is formed on a surface of the fusible link on the one side in the first direction from the cover locking portion and inside the cutout portion when the cover is mounted.
